(19) United States
(12) Patent Application Publication
(10) Pub. No.: US 2005/0034572 A1
(43) Pub. Date: Feb. 17, 2005

(54) Hand tool having an adjustable handle

(76) Inventor: Chih-Ching Hsien, Taichung (TW)

Correspondence Address: Chih-Ching Hsien, 58, MA YUAN WEST ST., TAICHUNG, TW

(21) Appl. No.: 10/641,921

(22) Filed: Aug. 12, 2003

(51) Int. Cl. B25B 23/16

(52) U.S. Cl. 81/177.2

(57) ABSTRACT

A hand tool includes an operation shank having a periphery formed with two opposite flattened faces each formed with an elongate slide slot, a movable handle slidably mounted on the operation shank, and two fixing pins each extended through the movable handle and each having a distal end slidably mounted in the slide slot of a respective one of the two opposite flattened faces of the operation shank. Thus, the movable handle can slide longitudinally so as to adjust the working length of the hand tool, thereby facilitating the user operating the hand tool.

### BACKGROUND OF THE INVENTION

1. Field of the Invention

The present invention relates to a hand tool, and more particularly to a hand tool having an adjustable handle that can slide longitudinally so as to adjust the working length of the hand tool, and can be pivoted so as to adjust the bent angle of the hand tool.

2. Description of the Related Art

A conventional hand tool, such as the wrench, socket or the like, usually comprises a handle and a driving portion integrally formed on one end of the handle. However, the handle has a fixed length, so that the working length of the conventional hand tool is fixed and cannot be adjusted, thereby limiting the versatility of the conventional hand tool.

### SUMMARY OF THE INVENTION

The primary objective of the present invention is to provide a hand tool having an adjustable handle that can slide longitudinally so as to adjust the working length of the hand tool, thereby facilitating the user operating the hand tool.

Another objective of the present invention is to provide a hand tool having an adjustable handle that can be pivoted so as to adjust the bent angle of the hand tool.

A further objective of the present invention is to provide a hand tool, wherein the movable handle is pivoted relative to the operation shank so as to adjust the bent angle of the hand tool, so that the bent hand tool can co-operate with a socket so as to rotate the screw member located at a comer.

In accordance with the present invention, there is provided a hand tool comprising:
an operation shank having a periphery formed with two opposite flattened faces each formed with an elongate slide slot;
a movable handle slidably mounted on the operation shank; and
two fixing pins each extended through the movable handle and each having a distal end slidably mounted in the slide slot of a respective one of the two opposite flattened faces of the operation shank.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand tool in accordance with the preferred embodiment of the present invention;

FIG. 2 is a perspective assembly view of the hand tool as shown in FIG. 1;

FIG. 3 is a side plan cross-sectional view of the hand tool as shown in FIG. 2;

FIG. 4 is a front plan cross-sectional view of the hand tool as shown in FIG. 2;

FIG. 5 is a schematic operational view of the hand tool as shown in FIG. 2;

FIG. 6 is a schematic plan operational view of the hand tool as shown in FIG. 2;

FIG. 7 is a perspective view of a hand tool in accordance with another embodiment of the present invention;

FIG. 8 is a perspective operational view of a hand tool in accordance with another embodiment of the present invention; and

FIG. 9 is a perspective view of a hand tool in accordance with another embodiment of the present invention.

### DETAILED DESCRIPTION OF THE INVENTION

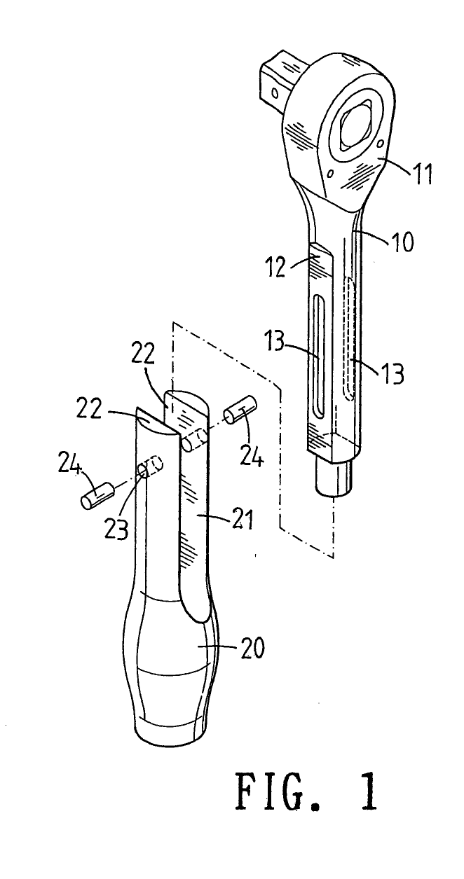

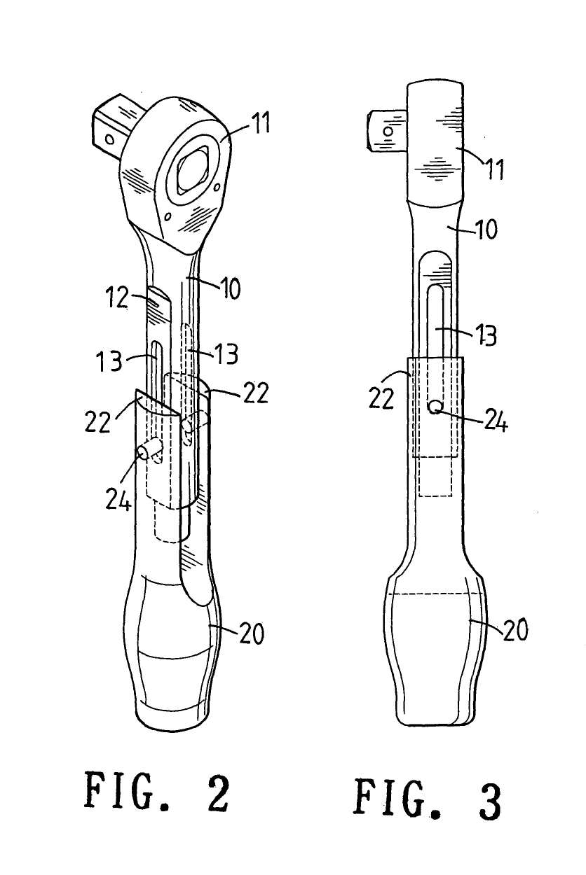

Referring to the drawings and initially to FIGS. 1-4, a hand tool in accordance with the preferred embodiment of the present invention comprises an operation shank 10, and a movable handle 20 slidably mounted on the operation shank 10.

The operation shank 10 has a cylindrical shape and has an end provided with a driving portion 11. The operation shank 10 has a periphery formed with two opposite flattened faces 12 each formed with an elongate slide slot 13. Preferably, the driving portion 11 of the operation shank 10 is a socket wrench.

The movable handle 20 has an inside formed with a receiving chamber 21 for receiving the operation shank 10, so that the movable handle 20 is slidably mounted on the operation shank 10. The receiving chamber 21 of the movable handle 20 has a wall formed with two opposite urging faces 22 each rested on a respective one of the two opposite flattened faces 12 of the operation shank 10, so that the movable handle 20 is positioned on the operation shank 10 rigidly and stably. Thus, the operation shank 10 can be rotated by rotation of the movable handle 20.

The hand toot further comprises two fixing pins 24 each extended through the movable handle 20 and each having a distal end slidably mounted in the slide slot 13 of a respective one of the two opposite flattened faces 12 of the operation shank 10. Preferably, the distal end of each of the two fixing pins 24 is extended into the receiving chamber 21 of the movable handle 20.

The movable handle 20 has a periphery formed with two opposite through holes 23 for receiving the two fixing pins 24. Preferably, each of the two opposite through holes 23 of the movable handle 20 communicates with the receiving chamber 21 of the movable handle 20.

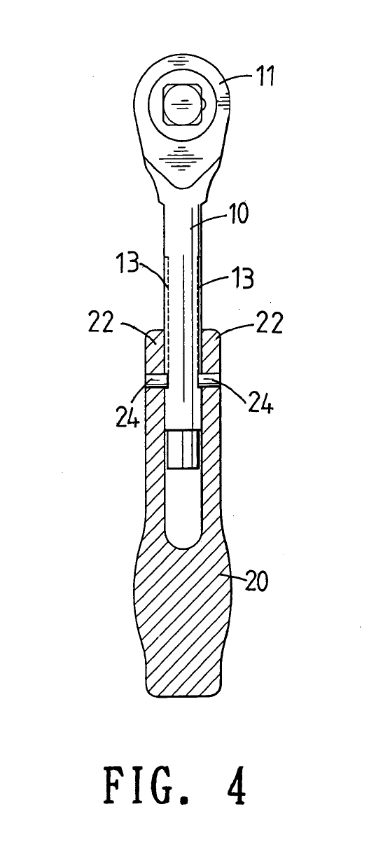

In operation, referring to FIG. 4 with reference to FIGS. 1-3, when the movable handle 20 is moved relative to the operation shank 10, each of the fixing pins 24 can slide in the slide slot 13 of a respective one of the two opposite flattened faces 12 of the operation shank 10, so that the movable handle 20 can slide longitudinally relative to the operation shank 10 so as to adjust the working length of the hand tool, thereby facilitating the user using and operating the hand tool.

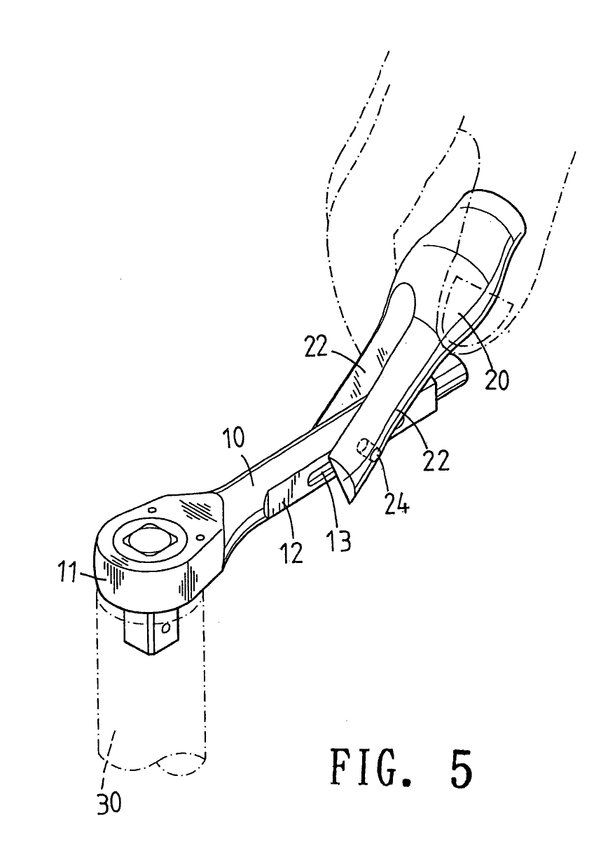

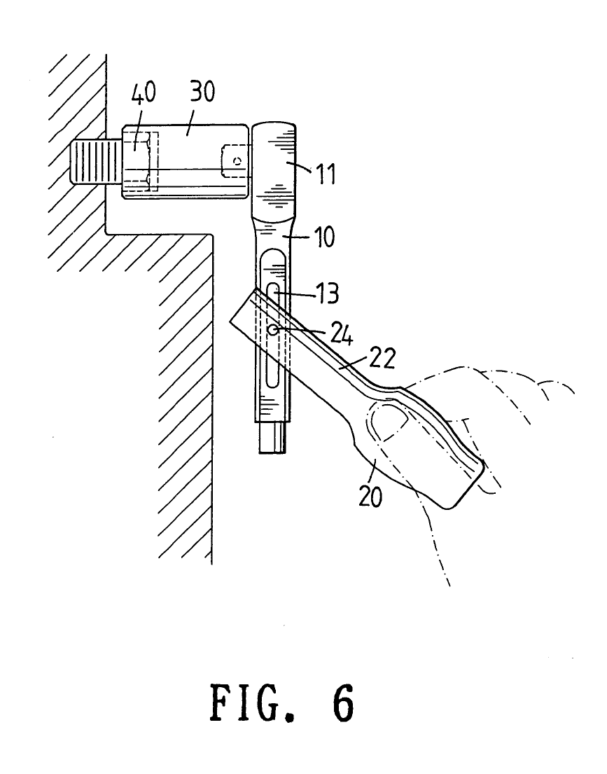

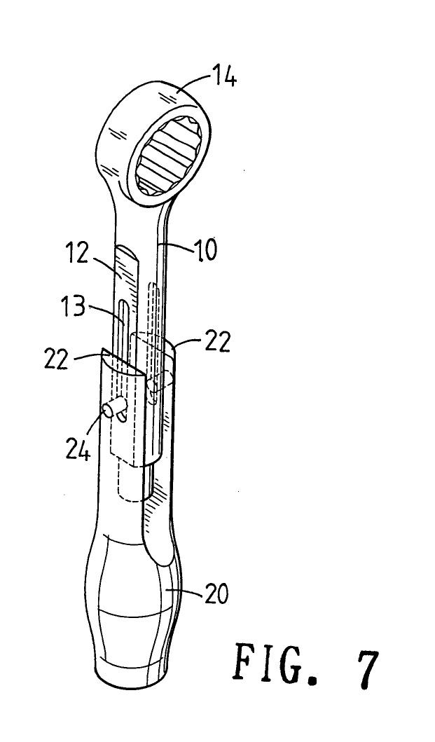

Referring to FIGS. 5 and 6, the movable handle 20 is pivoted about the two fixing pins 24 to move relative to the operation shank 10 to change the included angle between the movable handle 20 and the operation shank 10, so as to adjust the bent angle of the hand tool. Then, the driving portion 11 of the operation shank 10 is mounted on a socket 30 which is mounted on a screw member 40 located at a comer. At this time, each of the two opposite urging faces 22 of the movable handle 20 is rested on a respective one of the two opposite flattened faces 12 of the operation shank 10, so that the movable handle 20 is positioned on the operation shank 10 rigidly and stably. Thus, the operation shank 10 can be rotated by rotation of the movable handle 20 to rotate the socket 30 so as to rotate the screw member 40 located at a corner.

Referring to FIG. 7, in accordance with another embodiment of the present invention, the driving portion 14 of the operation shank 10 is a box-ended ratchet wrench.

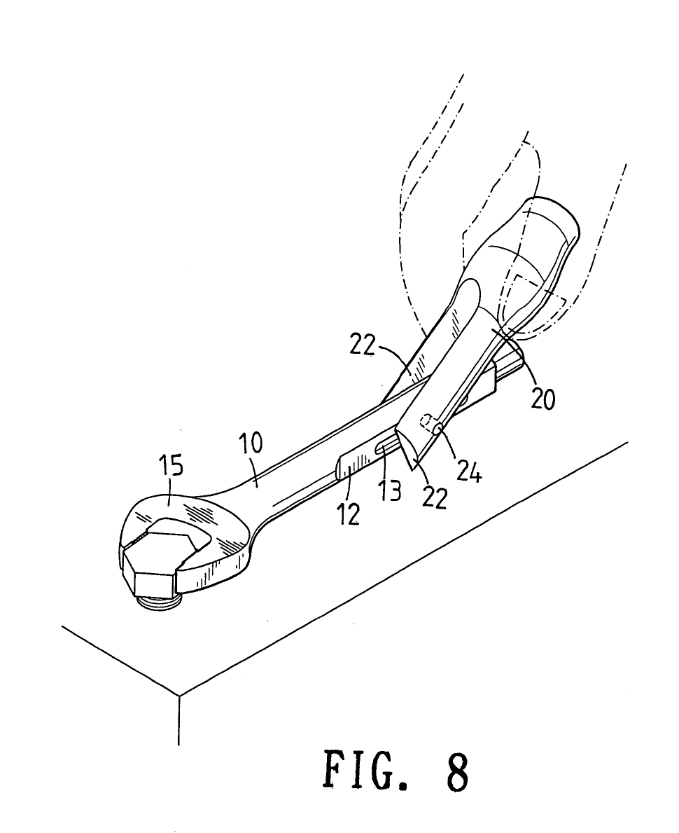

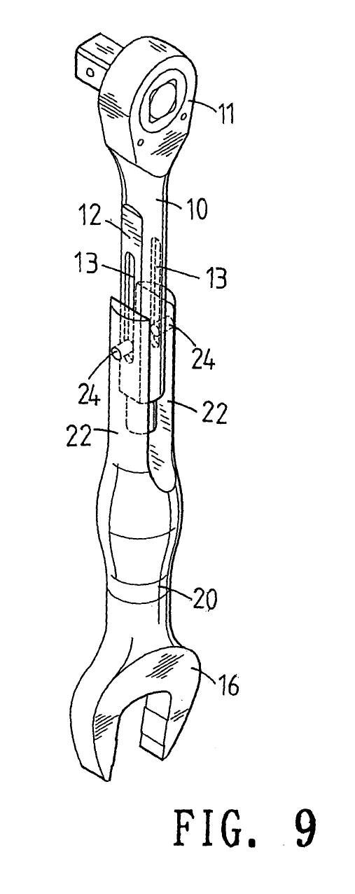

Referring to FIG. 8, in accordance with another embodiment of the present invention, the driving portion 15 of the operation shank 10 is an open-ended wrench.

Referring to FIG. 9, in accordance with another embodiment of the present invention, the movable handle 20 has an end provided with a driving portion 16 which is an open-ended wrench.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hand tool comprising:
an operation shank having a periphery formed with two opposite flattened faces each having a side formed with an elongate slide slot;
a movable handle slidably mounted on the operation shank; and
two opposite fixing pins each extended through and fixed in the movable handle and each having a distal end slidably mounted in the slide slot of a respective one of the two opposite flattened faces of the operation shank.

2. The hand tool in accordance with claim 1, wherein the movable handle has an inside formed with a receiving chamber for receiving the operation shank, so that the movable handle is slidably mounted on the operation shank.

3. The hand tool in accordance with claim 2, wherein the receiving chamber of the movable handle has a wall formed with two opposite flattened urging faces each closely rested on a respective one of the two opposite flattened faces of the operation shank, so that the movable handle is positioned on the operation shank.

4. The hand tool in accordance with claim 2, wherein the operation shank can be rotated by rotation of the movable handle.

5. The hand tool in accordance with claim 2, wherein the distal end of each of the two fixing pins is extended into the receiving chamber of the movable handle.

6. The hand tool in accordance with claim 1, wherein the movable handle has a periphery formed with two opposite through holes for receiving and fixing the two fixing pins.

7. The hand tool in accordance with claim 6, wherein the movable handle has an inside formed with a receiving chamber, and each of the two through holes of the movable handle communicates with the receiving chamber of the movable handle.

8. The hand tool in accordance with claim 1, wherein the operation shank has a cylindrical shape.

9. The hand tool in accordance with claim 1, wherein the operation shank has an end provided with a driving portion.

10. The hand tool in accordance with claim 9, wherein the driving portion of the operation shank is a socket wrench.

11. The hand tool in accordance with claim 9, wherein the driving portion of the operation shank is a box-ended ratchet wrench.

12. The hand tool in accordance with claim 9, wherein the driving portion of the operation shank is an open-ended wrench.

13. The hand tool in accordance with claim 1, wherein the movable handle has an end provided with a driving portion.

14. The hand tool in accordance with claim 13, wherein the driving portion of the movable handle is an open-ended wrench.
